(19) United States
(12) Patent Application Publication
(10) Pub. No.: US 2025/0095412 A1
(43) Pub. Date: Mar. 20, 2025

(54) AUTONOMOUS VEHICLES DETECTING AND REPORTING DEGRADED STATES OF PEERS

(71) Applicant: GM Cruise Holdings LLC, San Francisco, CA (US)

(72) Inventors: Domenico Rusciano, Concord, CA (US); Omair Siddiqui, San Pedro, CA (US); Arshad Zaman, San Francisco, CA (US); Jose Maciel Torres, Visalia, CA (US); Kunal Mehta, Redwood City, CA (US); Miles Avery Bowman, San Mateo, CA (US); Mamoon Masud, Austin, TX (US)

(73) Assignee: GM Cruise Holdings LLC, San Francisco, CA (US)

(21) Appl. No.: 18/467,542

(22) Filed: Sep. 14, 2023

(51) Int. Cl. G07C 5/00; G07C 5/08; H04W 4/46

(52) U.S. Cl. CPC G07C 5/008; G07C 5/0816; H04W 4/46

(57) ABSTRACT

An AV may detect degraded states of other AVs. For instance, the AV may use its sensors to detect one or more other vehicles in the local area. The AV may determine whether any of these vehicles is a peer of the AV based on features of these vehicles captured by its sensors. Alternatively, the AV may determine if any vehicle is a peer based on encrypted communication with the vehicle. The AV may also determine whether any peer AV has a state that deviates from an expected or desirable state. The AV may communicate with an online system and request the online system to provide information for identifying the vehicle or detecting degraded states. The AV may also report degradations in peer AVs to the online system. The online system may recover the degraded AV or dispatch another AV to complete a task assigned to the degraded AV.

### TECHNICAL FIELD OF THE DISCLOSURE

The present disclosure relates generally to autonomous vehicles (AVs) and, more specifically, to AVs detecting and reporting degraded states of peers.

### BACKGROUND

An AV is a vehicle that is capable of sensing and navigating its environment with little or no user input. An AV may sense its environment using sensing devices such as Radio Detection and Ranging (RADAR), Light Detection and Ranging (LIDAR), image sensors, cameras, and the like. An AV system may also use information from a global positioning system (GPS), navigation systems, vehicle-to-vehicle communication, vehicle-to-infrastructure technology, and/or drive-by-wire systems to navigate the vehicle. As used herein, the phrase “AV” includes both fully autonomous and semi-autonomous vehicles.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a system including a fleet of AVs that can provide services to users, according to some embodiments of the present disclosure;

FIG. 2 is a block diagram showing a sensor suite, according to some embodiments of the present disclosure;

FIG. 3 is a block diagram showing an onboard computer, according to some embodiments of the present disclosure;

FIG. 4 is a block diagram showing a peer degradation module, according to some embodiments of the present disclosure;

FIG. 5 is a block diagram showing a fleet management system, according to some embodiments of the present disclosure;

FIG. 6 is a block diagram showing a vehicle manager, according to some embodiments of the present disclosure;

FIG. 7 is a flowchart showing a method of detecting and reporting degraded states of AVs, according to some embodiments of the present disclosure; and

FIG. 8 illustrates a scene where an AV detects and reports a degraded state of another AV, according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

AVs can provide driverless ride services. A person can request an AV to pick him/her up from one location and drop him/her off at another location. With the autonomous driving features of the AV, the person does not have to drive during the ride and can be a passenger of the AV. The AV can navigate from the pick-up location to the drop-off location with no or little user input. AVs can provide other driverless services too, such as delivery service. A person can request an AV to deliver one or more items from one location to another location, and the person does not have to drive or be a passenger of the AV for the delivery.

States (e.g., appearance, behaviors, location, position, etc.) of AVs may be degraded while they are providing services. A degraded state deviates from the expected or desirable state of the AV, and such deviation can impair the performance of the AV during a driverless ride. For example, the driverless ride provided by the AV may become unsafe. As another example, the degraded state may introduce discomfort to the passenger of the AV. Examples of degraded states of AVs include contaminations to AV components, damages to AV components, malfunctions of AV components, undesirable AV maneuvers, improper AV locations, other types of deviations from the expected AV states, or some combination thereof. Degradations in AV states may be caused by external factors (e.g., weather, traffic condition, accident, etc.), internal factors (e.g., failure of AV components, etc.), or a combination of both. Currently available technologies fail to detect and address degraded states of AVs in a timely manner that can avoid the quality of AV rides from being diminished. Therefore, improved technologies for detecting and reporting degraded states of AVs are needed.

Embodiments of the present disclosure provide a peer degradation detection platform that can facilitate AVs to detect and to report degraded states of peer AVs. An AV that detects a degraded state of another AV is referred to as a detecting AV, and the other AV (i.e., the AV with the degraded state) is referred to as a peer AV or degraded AV. The peer AV may be in the same fleet of AVs (“AV fleet”) as the detecting AV. The AV fleet may be associated with an online system, e.g., a fleet management system that can manage operations of the AVs in the fleet and dispatch the AVs for various services. An AV, while driving in an area, may encounter its peers that are also driving (or parking) in the area. The autonomous driving features of the AV (e.g., sensors, onboard computer, etc.) can facilitate the AV to not only detect whether a peer AV has any degraded states but also to take actions to reduce or eliminate the impact of the degraded state on the performance of the peer AV. Examples of the actions may include reporting degraded state of the peer AV to the fleet management system, seeking remote assistance for the peer AV, and so on.

In various embodiments of the disclosure, an AV may detect a vehicle based on one or more sensors of the first AV. The one or more sensors may include a camera sensor, a LIDAR sensor, a RADAR sensor, and so on. After detecting the vehicle, the AV may determine whether the vehicle is an AV in an AV fleet, e.g., the same AV fleet that includes the AV itself. The AV may use various methods to determine whether the vehicle is a peer AV. In an example, the AV may input sensor data capturing the vehicle into a trained model, and the trained model may output a determination whether the vehicle is a peer AV or not. In another example, the AV may verify the identity of the vehicle by requesting an encrypted communication with the vehicle. In scenarios where the AV is uncertain about its determination (e.g., the confidence of the train model does not meet a threshold), the AV may send information of the vehicle to the fleet management system and request the fleet management system to verify the identity of the vehicle.

After determining that the vehicle is a peer AV, the detecting AV would detect whether the peer AV has any degraded states. The detecting AV may compare a detected state of the peer AV with a reference state. The reference state may be an expected state or a desirable state. The detecting AV may determine the reference state based on an operational plan (e.g., operational design domain (ODD), etc.) applicable to the peer AV. The operational plan may be stored in a memory of the detecting AV or may be received by the detecting AV from the fleet management system.

In embodiments where a degraded state of the peer AV is detected, the detecting AV may send information of the degraded state to the fleet management system. The fleet management system may take actions to help the peer recover from the degraded state or dispatch another AV to replace the degraded AV. The fleet management system may also send one or more messages to a client device associated with the user who requests the service provided by the degraded AV. A message may include information describing the AV degradation, a solution, a change to the service, and so on. Also, the fleet management system or the detecting AV may request remote assistance for the degraded AV.

The present disclosure provides methods and systems that can take advantage of existing autonomous driving features of AVs to detect and to report degraded states of their peers. Therefore, the degradations of AVs can be timelier detected and addressed, compared with currently available technologies. It can reduce or even avoid the negative impact of the degraded states on the quality of AV services.

As will be appreciated by one skilled in the art, aspects of the present disclosure, in particular aspects of AV sensor calibration, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

### Example System Including AVs

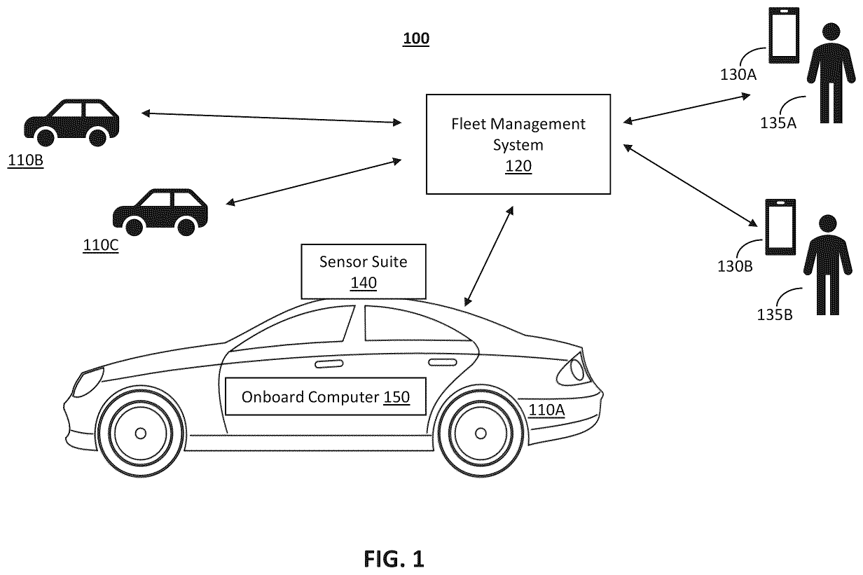

FIG. 1 illustrates a system 100 including a fleet of AVs that can provide services to users, according to some embodiments of the present disclosure. The system 100 includes AVs 110A-110C (collectively referred to as “AVs 110” or “AV 110”), a fleet management system 120, and client devices 130A and 130B (collectively referred to as “client devices 130” or “client device 130”). The client devices 130A and 130B are associated with users 135A and 135B, respectively. The AV 110A includes a sensor suite 140 and an onboard computer 150. Even though not shown in FIG. 1, the AV 110B or 110C can also include a sensor suite 140 and an onboard computer 150. In other embodiments, the system 100 may include more, fewer, or different components. For example, the fleet of AVs 110 may include a different number of AVs 110 or a different number of client devices 130.

The fleet management system 120 manages the fleet of AVs 110. The fleet management system 120 may manage operations of the AVs 110. For instance, the fleet management system 120 may provide software (“AV software”) to the fleet of AVs 110. The software, when executed by processors, may control operations of the AVs 110. The fleet management system 120 may provide different software to different AVs 110. The fleet management system 120 may also update software, e.g., by changing one or more components in a version of the AV software and releasing a new software version. The fleet management system 120 may also provide information to AVs 110 for the AVs 110 to operate based on the information. For instance, the fleet management system 120 may provide information about environmental conditions to AVs 110. An environment condition may be a condition in an environment where one or more AVs 110 operate or will operate. Examples of environmental conditions include weather condition (e.g., rain, snow, wind, etc.), road condition (e.g., road closures, water accumulation, road grade indicating a rate of change of the road elevation, etc.), traffic condition (e.g., traffic congestion, accidents, etc.), other types of environmental conditions, or some combination thereof. An AV 110 may use one or more environmental conditions to control its operation, e.g., to control its motions in the environment.

In some embodiments, the fleet management system 120 may manage one or more services that the fleet of AVs 110 provides to the users 135. An example service is a ride service, e.g., an AV 110 provides a ride to a user 135 from a first location to a second location. Another example service is a delivery service, e.g., an AV 110 delivers one or more items from or to the user 135. The fleet management system 120 can select one or more AVs 110 (e.g., AV 110A) to perform a particular service, and instructs the selected AV to drive to one or more particular locations associated with the service (e.g., a first address to pick up user 135A, and a second address to pick up user 135B). The fleet management system 120 also manages fleet maintenance tasks, such as fueling, inspecting, and servicing of the AVs. As shown in FIG. 1, the AVs 110 communicates with the fleet management system 120. The AVs 110 and fleet management system 120 may connect over a network, such as the Internet.

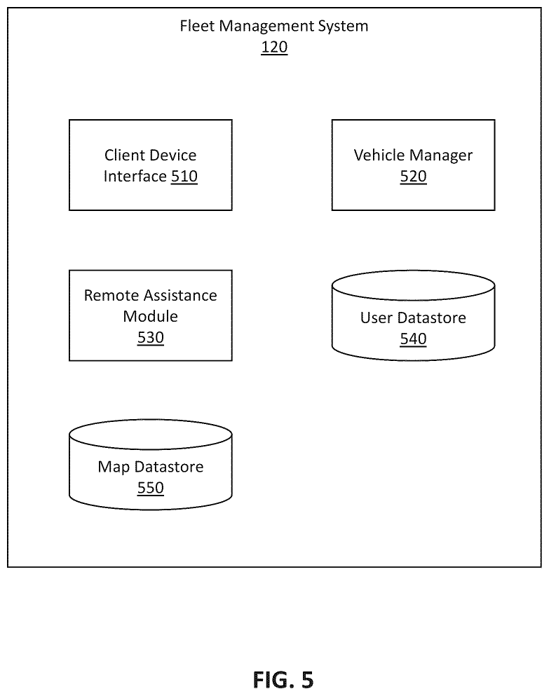

In some embodiments, the fleet management system 120 may receive service requests for the AVs 110 from the client devices 130. In an example, the user 135A may access an app executing on the client device 130A and requests a ride from a pickup location (e.g., the current location of the client device 130A) to a destination location. The client device 130A may transmit the ride request to the fleet management system 120. The fleet management system 120 may select an AV 110 from the fleet of AVs 110 and dispatches the selected AV 110A to the pickup location to carry out the ride request. In some embodiments, the ride request may further include a number of passengers in the group. In some embodiments, the ride request may indicate whether a user 135 is interested in a shared ride with another user travelling in the same direction or along the same portion of a route. The ride request, or settings previously entered by the user 135, may further indicate whether the user 135 is interested in interaction with another passenger. The fleet management system 120 may be implemented in the Cloud. Certain aspects of the fleet management system 120 are described below in conjunction with FIG. 5.

A client device 130 may be a device capable of communicating with the fleet management system 120, e.g., via one or more networks. The client device 130 can transmit data to the fleet management system 120 and receive data from the fleet management system 120. The client device 130 can also receive user input and provide outputs. In some embodiments, outputs of the client devices 130 are in human-perceptible forms, such as text, graphics, audio, video, and so on. The client device 130 may include various output components, such as monitors, speakers, headphones, projectors, and so on. The client device 130 may be a desktop or a laptop computer, a smartphone, a mobile telephone, a personal digital assistant (PDA), or another suitable device.

In some embodiments, a client device 130 executes an application allowing a user 135 of the client device 130 to interact with the fleet management system 120. For example, a client device 130 executes a browser application to enable interaction between the client device 130 and the fleet management system 120 via a network. In another embodiment, a client device 130 interacts with the fleet management system 120 through an application programming interface (API) running on a native operating system of the client device 130, such as IOS® or ANDROID™. The application may be provided and maintained by the fleet management system 120. The fleet management system 120 may also update the application and provide the update to the client device 130.

In some embodiments, a user 135 may submit one or more service requests to the fleet management system 120 through a client device 130. A client device 130 may provide its user 135 a user interface (UI), through which the user 135 can make service requests, such as ride request (e.g., a request to pick up a person from a pickup location and drop off the person at a destination location), delivery request (e.g., a request to deliver one or more items from a location to another location), and so on. The UI may allow users 135 to provide locations (e.g., pickup location, destination location, etc.) or other information that would be needed by AVs 110 to provide services requested by the users 135. The client device 130 may also provide the user 135 an UI through which the user 135 may specify preference for AV motions during an AV service that has been requested or to be requested by the user 135. For example, the user 135 may specify, through the UI, how fast the user 135 prefers the AV 110 to move, turn, stop, accelerate, or decelerate.

The AV 110 is preferably a fully autonomous automobile, but may additionally or alternatively be any semi-autonomous or fully autonomous vehicle, e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. In some embodiments, some or all of the vehicle fleet managed by the fleet management system 120 are non-autonomous vehicles dispatched by the fleet management system 120, and the vehicles are driven by human drivers according to instructions provided by the fleet management system 120.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

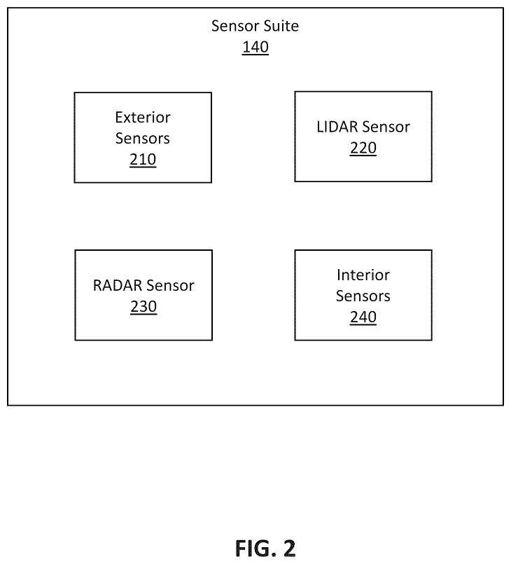

The sensor suite 140 may detect conditions inside and outside the AV 110. For instance, the sensor suite 140 may detect conditions in an environment surrounding the AV 110. The sensor suite 140 may include a computer vision (“CV”) system, localization sensors, and driving sensors. For example, the sensor suite 140 may include interior and exterior cameras, RADAR sensors, sonar sensors, LIDAR sensors, thermal sensors, wheel speed sensors, inertial measurement units (IMUs), accelerometers, microphones, strain gauges, pressure monitors, barometers, thermometers, altimeters, ambient light sensors, etc. The sensors may be located in various positions in and around the AV 110. For example, the AV 110 may have multiple cameras located at different positions around the exterior and/or interior of the AV 110. Certain sensors of the sensor suite 140 are described further in relation to FIG. 2.

The onboard computer 150 is connected to the sensor suite 140 and functions to control the AV 110 and to process sensed data from the sensor suite 140 and/or other sensors to determine the state of the AV 110 or the state of other AVs 110 in the fleet of AVs 110. Based upon the vehicle state and programmed instructions, the onboard computer 150 modifies or controls the behavior of the AV 110. The onboard computer 150 may preferably be a general-purpose computer adapted for I/O communication with vehicle control systems and sensor suite 140 but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems.

In some embodiments, the onboard computer 150 is in communication with the fleet management system 120, e.g., through a network. The onboard computer 150 may receive instructions from the fleet management system 120 and control behavior of the AV 110 based on the instructions. For example, the onboard computer 150 may receive from the fleet management system 120 an instruction for providing a ride to a user 135. The instruction may include information of the ride (e.g., pickup location, drop-off location, intermediate stops, etc.), information of the user 135 (e.g., identifying information of the user 135, contact information of the user 135, etc.). The onboard computer 150 may determine a navigation route of the AV 110 based on the instruction.

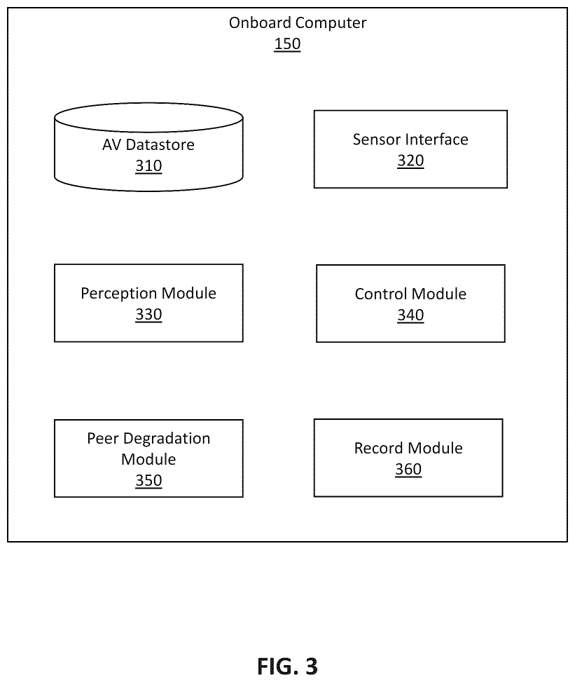

As another example, the onboard computer 150 may receive from the fleet management system 120 a request for sensor data to be used for determining environmental conditions. The onboard computer 150 may control one or more sensors of the sensor suite 140 to detect the user 135, the AV 110, or an environment surrounding the AV 110 based on the instruction and further provide the sensor data from the sensor suite 140 to the fleet management system 120. The onboard computer 150 may transmit other information requested by the fleet management system 120, such as perception of the AV 110 that is determined by a perception module of the onboard computer 150, historical data of the AV 110, and so on. Certain aspects of the onboard computer 150 are described further in relation to FIG. 3.

### Example Sensor Suite

FIG. 2 is a block diagram showing the sensor suite 140, according to some embodiments of the present disclosure. The sensor suite 140 may be an onboard sensor suite of an AV, e.g., AV 110 in FIG. 1. The sensor suite 140 includes exterior sensors 210, a LIDAR sensor 220, a RADAR sensor 230, and interior sensors 240. The sensor suite 140 may include any number of the types of sensors shown in FIG. 2, e.g., one or more LIDAR sensors 220, one or more RADAR sensors 230, etc. The sensor suite 140 may have more types of sensors than those shown in FIG. 2, such as the sensors described with respect to FIG. 1. In other embodiments, the sensor suite 140 may not include one or more of the sensors shown in FIG. 2.

The exterior sensors 210 may detect objects in an environment around the AV. The environment may include a scene in which the AV operates. Example objects include vehicles, street signs, trees, plants, animals, persons, buildings, traffic lights, traffic signs, objects related to weather (e.g., fog, rain, snow, haze, etc.), or other types of objects that may be present in the environment around the AV. In some embodiments, the exterior sensors 210 include exterior cameras having different views, e.g., a front-facing camera, a back-facing camera, and side-facing cameras. One or more exterior sensors 210 may be implemented using a high-resolution imager with a fixed mounting and field of view. One or more exterior sensors 210 may have adjustable field of views and/or adjustable zooms. In some embodiments, the exterior sensors 210 may operate continually during operation of the AV. In an example embodiment, the exterior sensors 210 capture sensor data (e.g., images, etc.) of a scene in which the AV drives. In other embodiments, the exterior sensors 210 may operate in accordance with an instruction from the onboard computer 150 or an external system, such as the vehicle manager 520 of the fleet management system 120. Some of all of the exterior sensors 210 may capture sensor data of one or more objects in an environment surrounding the AV based on the instruction.

The LIDAR sensor 220 may measure distances to objects in the vicinity of the AV using reflected laser light. The LIDAR sensor 220 may be a scanning LIDAR that provides a point cloud of the region scanned. The LIDAR sensor 220 may have a fixed field of view or a dynamically configurable field of view. The LIDAR sensor 220 may produce a point cloud that describes, among other things, distances to various objects in the environment of the AV.

The RADAR sensor 230 may measure ranges and speeds of objects in the vicinity of the AV using reflected radio waves. The RADAR sensor 230 may be implemented using a scanning RADAR with a fixed field of view or a dynamically configurable field of view. The RADAR sensor 230 may include one or more articulating RADAR sensors, long-range RADAR sensors, short-range RADAR sensors, or some combination thereof.

The interior sensors 240 may detect the interior of the AV, such as objects inside the AV. Example objects inside the AV include users (e.g., passengers), client devices of users, components of the AV, items delivered by the AV, items facilitating services provided by the AV, and so on. The interior sensors 240 may include multiple interior cameras to capture different views, e.g., to capture views of an interior feature, or portions of an interior feature. The interior sensors 240 may be implemented with a fixed mounting and fixed field of view, or the interior sensors 240 may have adjustable field of views and/or adjustable zooms, e.g., to focus on one or more interior features of the AV. The interior sensors 240 may transmit sensor data to a perception module (such as the perception module 330 described below in conjunction with FIG. 3), which can use the sensor data to classify a feature and/or to determine a status of a feature.

In some embodiments, the interior sensors 240 include one or more input sensors that allow users 135 to provide input. For instance, a user 135 may use an input sensor to provide information indicating his/her preference for one or more motions of the AV during the ride. The input sensors may include touch screen, microphone, keyboard, mouse, or other types of input devices. In an example, the interior sensors 240 include a touch screen that is controlled by the onboard computer 150. The onboard computer 150 may present questionnaires on the touch screen and receive user answers to the questionnaires through the touch screen. A questionnaire may include one or more questions about AV motions. The onboard computer 150 may receive the questions from the fleet management system 120. In some embodiments, some or all of the interior sensors 240 may operate continually during operation of the AV. In other embodiments, some or all of the interior sensors 240 may operate in accordance with an instruction from the onboard computer 150 or an external system, such as the fleet management system 120.

### Example Onboard Computer

FIG. 3 is a block diagram showing the onboard computer 150 according to some embodiments of the present disclosure. The onboard computer 150 may control an AV, e.g., AV 110 in FIG. 1. The AV may be a detecting AV that can detect and report degraded states of peer AVs. As shown in FIG. 3, the onboard computer 150 includes an AV datastore 310, a sensor interface 320, a perception module 330, a control module 340, a peer degradation module 350, and a record module 360. In alternative configurations, fewer, different and/or additional components may be included in the onboard computer 150. For example, components and modules for conducting route planning, controlling movements of the AV, and other vehicle functions are not shown in FIG. 3. Further, functionality attributed to one component of the onboard computer 150 may be accomplished by a different component included in the onboard computer 150 or a different system, such as the fleet management system 120.

The AV datastore 310 stores data associated with operations of the AV. The AV datastore 310 may store one or more operation records of the AV. An operation record is a record of an operation of the AV, e.g., an operation for providing a ride service. The operation record may include information indicating operational behaviors of the AV during the operation. The operations record may also include data used, received, or captured by the AV during the operation, such as map data, instructions from the fleet management system 120, sensor data captured by the AV, and so on. In some embodiments, the AV datastore 310 stores a detailed map that includes a current environment of the AV. The AV datastore 310 may store data in the map datastore 250. In some embodiments, the AV datastore 310 stores a subset of the map datastore 250, e.g., map data for a city or region in which the AV is located.

The sensor interface 320 interfaces with the sensors in the sensor suite 140. The sensor interface 320 may request data from the sensor suite 140, e.g., by requesting a sensor to capture data in a particular direction or at a particular time. For example, the sensor interface 320 instructs the sensor suite 140 to capture sensor data of an environment surrounding the AV, e.g., by sending a request for sensor data to the sensor suite 140. In some embodiments, the request for sensor data may specify which sensor(s) in the sensor suite 140 to provide the sensor data, and the sensor interface 320 may request the sensor(s) to capture data. The request may further provide one or more settings of a sensor, such as orientation, resolution, accuracy, focal length, and so on. The sensor interface 320 can request the sensor to capture data in accordance with the one or more settings.

A request for sensor data may be a request for real-time sensor data, and the sensor interface 320 can instruct the sensor suite 140 to immediately capture the sensor data and to immediately send the sensor data to the sensor interface 320. The sensor interface 320 is configured to receive data captured by sensors of the sensor suite 140, including data from exterior sensors mounted to the outside of the AV, and data from interior sensors mounted in the passenger compartment of the AV. The sensor interface 320 may have subcomponents for interfacing with individual sensors or groups of sensors of the sensor suite 140, such as a camera interface, a LIDAR interface, a RADAR interface, a microphone interface, etc.

The perception module 330 identifies objects and/or other features captured by the sensors of the AV. For example, the perception module 330 identifies objects in the environment of the AV and captured by one or more sensors (e.g., the sensors 210-230). As another example, the perception module 330 determines one or more environmental conditions based on sensor data from one or more sensors (e.g., the sensors 210-230). The perception module 330 may include one or more classifiers trained using machine learning to identify particular objects. For example, a multi-class classifier may be used to classify each object in the environment of the AV as one of a set of potential objects, e.g., a vehicle, a pedestrian, or a cyclist. As another example, a pedestrian classifier recognizes pedestrians in the environment of the AV, a vehicle classifier recognizes vehicles in the environment of the AV, etc.

The perception module 330 may identify travel speeds of identified objects based on data from the RADAR sensor 230, e.g., speeds at which other vehicles, pedestrians, or birds are travelling. As another example, the perception module 33—may identify distances to identified objects based on data (e.g., a captured point cloud) from the LIDAR sensor 220, e.g., a distance to a particular vehicle, building, or other feature identified by the perception module 330. The perception module 330 may also identify other features or characteristics of objects in the environment of the AV based on image data or other sensor data, e.g., colors (e.g., the colors of lights), sizes (e.g., heights of people or buildings in the environment), makes and models of vehicles, pictures and/or words on billboards, etc.

In some embodiments, the perception module 330 fuses data from one or more interior sensors 240 with data from exterior sensors (e.g., exterior sensors 210) and/or AV datastore 310 to identify environmental objects that one or more users are looking at. The perception module 330 determines, based on an image of a user, a direction in which the user is looking, e.g., a vector extending from the user and out of the AV in a particular direction. The perception module 330 compares this vector to data describing features in the environment of the AV, including the features' relative location to the AV (e.g., based on real-time data from exterior sensors and/or the AV's real-time location) to identify a feature in the environment that the user is looking at.

While a single perception module 330 is shown in FIG. 3, in some embodiments, the onboard computer 150 may have multiple perception modules, e.g., different perception modules for performing different ones of the perception tasks described above (e.g., object perception, speed perception, distance perception, feature perception, facial recognition, mood determination, sound analysis, gaze determination, etc.).

The control module 340 controls operations of the AV, e.g., based on information from the sensor interface 320 or the perception module 330. The control module 340 may determine motion capacities of the AV, e.g., based on conditions in environments where the AV operates, preferences of users requesting services conducted by the AV, other types of information, or some combination thereof. In some embodiments, the control module 340 may include multiple planning modules (also referred to as “planners”) that can plan motions of the AV during the AV's operations based on information from the fleet management system 120, information from the sensor interface 320 or perception module 330, other information, or some combination thereof. The planning modules may determine a motion parameter that specifies a motion to be performed by the AV in the operation. The motion parameter may be a speed, acceleration rate, deceleration rate, jerk, snap, curvature, orientation, etc. Different planning modules may make different plans for the AV. The planning modules may use different models to make the different plans. In some embodiments, the planning modules may produce a single plan for the operation of the AV. In an example, the planning modules may run in a sequence. For instance, a planning module may generate a plan, and another planning module may generate another plan based on the plan. The output from the last planning module in the sequence may be the final plan for the AV's operation. The output may include commands, e.g., commands to one or more actuators in the AV.

In some embodiments, the control module 340 controls operation of the AV by using a trained model, such as a trained neural network. The control module 340 may provide input data to the control model, and the control model outputs operation parameters for the AV. The input data may include sensor data from the sensor interface 320 (which may indicate a current state of the AV), objects identified by the perception module 330, or both. The operation parameters are parameters indicating operation to be performed by the AV. The operation of the AV may include perception, prediction, planning, localization, motion, navigation, other types of operation, or some combination thereof.

The control module 340 may provide instructions to various components of the AV based on the output of the control model, and these components of the AV will operate in accordance with the instructions. In an example where the output of the control model indicates that a change of travelling speed of the AV is required given a prediction of traffic condition, the control module 340 may instruct the motor of the AV to change the travelling speed of the AV. In another example where the output of the control model indicates a need to detect characteristics of an object in the environment around the AV (e.g., detect a speed limit), the control module 340 may instruct the sensor suite 140 to capture an image of the speed limit sign with sufficient resolution to read the speed limit and instruct the perception module 330 to identify the speed limit in the image. In some embodiments, the control module 340 may control one or more actuators in the AV based on an output of one or more planners. In some embodiments, the control module 340 may execute commands in the output of a planner to drive operations of the one or more actuators. The operations of the actuators can cause the AV motions planned by the planner.

The peer degradation module 350 detects and reports degradations of other AVs. The peer degradation module 350 may detect whether there are any vehicles in the surrounding area based on sensor data from the sensor interface 320 or perception data from the perception module 330. After a vehicle is detected, the peer degradation module 350 may determine whether the vehicle is a peer AV. A peer AV may be another AV associated with the fleet management system 120 or another AV that is in the fleet of AVs 110. The peer degradation module 350 may make the determination based on sensor data from the sensor interface 320, perception data from the perception module 330, encrypted communication with the vehicle, information from the fleet management system 120, other information, or some combination thereof.

The peer degradation module 350 may also detect the state of each detected peer AV and compare the state of each detected peer AV with a reference state. The state of a peer AV may be detected by the sensor suite 140. The reference state may be obtained based on an operational plan applicable to the peer AV The operational plan may be stored in a memory, e.g., the AV datastore 310. Alternatively, the peer degradation module 350 may request the fleet management system 120 to provide the operational plan or the reference state of the peer AV. In some embodiments, the operational plan may be applicable to both the detecting AV and the peer AV. In other embodiments, the operational plan may be specific to a particular peer AV.

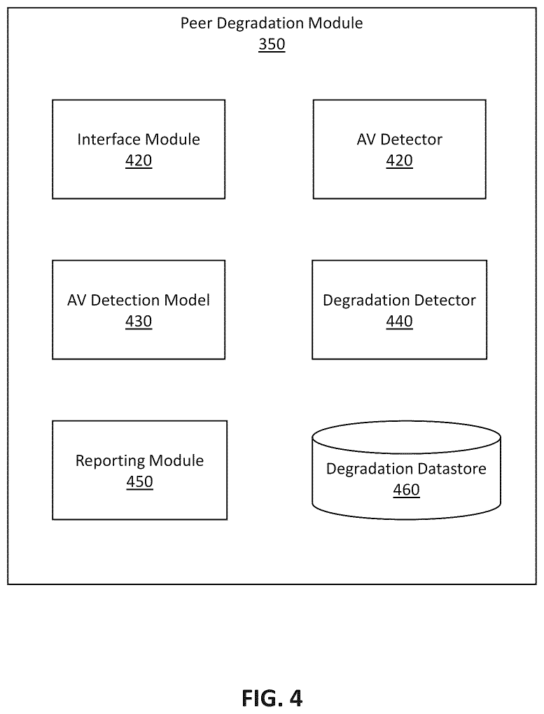

The peer degradation module 350 may further take actions to address degraded states of peer AVs. For example, the peer degradation module 350 may report the degraded states of peer AVs to the fleet management system 120. The peer degradation module 350 may provide information of a degraded state to the fleet management system 120, such as description of the degraded state, the severity of the degradation, environmental conditions (e.g., objects surrounding the peer AV, weather conditions, traffic conditions, etc.). The information may be used by the fleet management system 120 or the peer degradation module 350 to reduce or eliminate negative impact caused by the degraded state of the peer AV. Certain aspects of the peer degradation module 350 are provided below in conjunction with FIG. 4.

The record module 360 generates operation records of the AV and stores the operations records in the AV datastore 310. The record module 360 may generate an operation record in accordance with an instruction from the fleet management system 120, e.g., the vehicle manager 520. The instruction may specify data to be included in the operation record. The record module 360 may determine one or more timestamps for an operation record. In an example of an operation record for a ride service, the record module 360 may generate timestamps indicating the time when the ride service starts, the time when the ride service ends, times of specific AV behaviors associated with the ride service, and so on. The record module 360 can transmit the operation record to the fleet management system 120.

### Example Peer Degradation Module

FIG. 4 is a block diagram showing a peer degradation module 350, according to some embodiments of the present disclosure. The peer degradation module 350 includes an interface module 410, an AV detector 420, an AV detection model 430, a degradation detector 440, a reporting module 450, and a degradation datastore 460. In alternative configurations, different and/or additional components may be included in the peer degradation module 350. Further, functionality attributed to one component of the peer degradation module 350 may be accomplished by a different component included in the peer degradation module 350, a different component included in the onboard computer 150, or a different system (such as the fleet management system 120).

The interface module 410 facilitates communications of the peer degradation module 350 with other modules or systems. In some embodiments, the interface module 410 may facilitate communications of the peer degradation module 350 with the sensor interface 320. For instance, the interface module 410 may send requests for capturing sensor data to the sensor interface 320 or receive sensor data from the sensor interface 320. The interface module 410 may also facilitate communications of the peer degradation module 350 with the perception module 330. For instance, the interface module 410 may receive classifications of objects (e.g., vehicles) or features of objects that are perceived by the perception module 330. In some embodiments, the interface module 410 may facilitate communications of the peer degradation module 350 with the fleet management system 120, such as the vehicle manager 520 in the fleet management system 120. For instance, the interface module 410 may send requests for verifying identities of peer AVs to the vehicle manager 520. The interface module 410 may also receive responses to such requests (or to other requests) from the fleet management system 120.

The AV detector 420 detects peer AVs present in environments where the detecting AV operates, including local areas where the detecting AV drives. In some embodiments, the AV detector 420 may detect vehicles using sensors of the detecting AV, e.g., sensors in the sensor suite 140. After a vehicle is detected, the AV detector 420 may determine whether the vehicle is a peer AV. A peer AV may be an AV that is in the same fleet of AVs as the detecting AV, e.g., an AV that is associated with the fleet management system 120. The AV detector 420 may use information from other modules or systems for detecting peer AVs, such as classifications of objects made by the perception module 330, verification of AV identifies from the fleet management system 120, and so on.

In some embodiments, the AV detector 420 may use the AV detection model 430 to detect peer AVs. The AV detection model 430 may be a model trained with machine learning techniques. The AV detector 420 may input sensor data captured by the sensor suite 140 into the AV detection model 430. The AV detection model 430 may output a determination whether there is any peer AV surrounding the detecting AV. For instance, the AV detection model 430 may classify one or more objects captured in the sensor data and determine whether the one or more objects fall into the class of peers of the detecting AV.

The AV detector 420 may include or be associated with a training module that trains the AV detection model 430. As part of the generation of the AV detection model 430, a training set may be formed. The training set may include training samples and ground-truth labels of the training samples. A training sample may include a set of sensor data captured by a detecting A. The training sample may have one or more ground-truth labels, e.g., a verified or known determination whether there is any peer AV surrounding the detecting AV. The training set may include one or more positive training samples and one or more negative training samples. A positive training sample has a ground-truth label indicating that there is a peer AV surrounding a detecting AV. A negative training sample has a ground-truth label indicating that there is no peer AV surrounding a detecting AV. Features may be extracted from the training set, the features being variables deemed potentially relevant to determining whether there is any peer AV surrounding the detecting AV. An ordered list of the features may be a feature vector.

In some embodiments, the training module may apply dimensionality reduction (e.g., via linear discriminant analysis (LDA), principal component analysis (PCA), or the like) to reduce the amount of data in the feature vectors to a smaller, more representative set of data. The training module may use supervised machine learning to train the model. Different machine learning techniques-such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps-may be used in different embodiments.

In some embodiments, the AV detector 420 may communicate with the fleet management system 120, e.g., through the interface module 410, to verify determinations of the AV detection model 430. For instance, the AV detector 420 may determine whether the confidence of the AV detection model 430 meets a threshold. The AV detection model 430 may output a confidence score that indicates how confident the AV detection model 430 is that an object detected by the detecting AV is a peer AV. In some embodiments, the confidence score may be a probability of the object falling into the peer AV class. The AV detector 420 may compare the confidence score with the threshold. In embodiments where the confidence score is below the threshold, the AV detector 420 may request the fleet management system 120 to verify whether the detected object is a peer AV. The AV detector 420 may provide information associated with the detected object to the fleet management system 120. The information may include the sensor data captured by the detecting AV, perceptions made by the detecting AV, and so on. The AV detector 420 may receive a response from the fleet management system 120, and the response may indicate whether the detected AV is indeed a peer AV.

The AV detector 420 or the training module may continuously train the AV detection model 430. For instance, the AV detector 420 may receive a verification from the fleet management system 120, and the verification may indicate whether a peer AV detected by the AV detection model 430 is indeed a peer AV or not. The AV detector 420 or the training module may form a new training sample, which includes the sensor data used to detect the peer AV. The AV detector 420 or the training module may also generate a ground-truth label based on the verification from the fleet management system 120. The AV detector 420 or the training module may use the new training sample and the ground-truth label to further train the AV detection model 430. In embodiments where the verification from the fleet management system 120 confirms that the determination of the AV detection model 430 is correct, the new training sample may be used as a positive training sample. In embodiments where the verification from the fleet management system 120 indicates that the determination of the AV detection model 430 is incorrect, the new training sample may be used as a negative training sample.

In addition or alternative to using the AV detection model 430, the AV detector 420 may use other approaches to detect peer AVs. In some embodiments, the AV detector 420 may detect peer AVs based on encrypted communications with the peer AVs. The encrypted communications between AVs in the same fleet of AVs may have been enabled, e.g., by the fleet management system 120. For instance, the fleet management system 120 may provide an encrypted communication protocol to AVs managed by the fleet management system 120. The AVs may establish encrypted communication with each other based on the encrypted communication protocol.

The AV detector 420 may send out a request for establishing wireless communication to a vehicle, e.g., after the vehicle is perceived by the detecting AV. In some embodiments, the wireless communication is based on an encrypted communication protocol, which may be provided to the AV detector 420 by the fleet management system 120. In some embodiments, the AV detector 420 may receive a token from the detected vehicle as a response to the request for establishing wireless communication. The AV detector 420 may verify the token, e.g., by determining whether the token matches a token provided by the fleet management system 120. The AV detector 420 may establish wireless communication with the detected vehicle after the token is verified. The AV detector 420 may determine that the vehicle is a peer AV in response to a successful establishment of wireless communication with the vehicle. In embodiments where a token is not received or a received token cannot be verified, the AV detector 420 may determine that the vehicle is not a peer AV.

The degradation detector 440 determines whether detected peer AV are in degraded states. A degraded state of a peer AV may be a deviation from a reference state of the peer AV. Examples of degraded states include contaminations to AV components (e.g., sensor, vehicle body, windshield, lights, brake, door, etc.), damages to AV components, malfunction of AV components, failure of AV components, undesirable AV behaviors (e.g., AV maneuvers that can cause safety concerns, passenger discomfort, etc.), improper AV orientations (positions or locations), other types of deviations from expected AV states, or some combination thereof.

In some embodiments, the degradation detector 440 detects whether a peer AV has any degraded state by comparing a detected state of the peer AV with a reference state. The degradation detector 440 may determine the state of the peer AV based on sensor data capturing one or more features of the peer AV and determine the reference state based on additional data indicating one or more reference states of the peer AV. The additional data may indicate one or more reference states applicable to some or all AVs in the fleet of AVs, such as traffic rules, operational plan, and so on. Additionally or alternatively, the additional data may indicate one or more reference states that are specific to the peer AV, such as a travelling plan predetermined for the peer AV (e.g., for performing a service requested by a user), specifications of the peer AV (e.g., color of the peer AV, design of the peer AV, components of the peer AV, etc.), and so on.

In some embodiments, the additional data may be data indicating a state of another AV that has no degradation. In other embodiments, the additional data may be reference data from a historical record or manual for a component of the AV, the AV, or the fleet to which the AV belongs. The degradation detector 440 may retrieve the additional data from a memory, e.g., a cache associated with the onboard computer 150. The degradation detector 440 may also receive the additional data from the fleet management system 120. For instance, the degradation detector 440 may request the fleet management system 120 to provide the additional data.

In some embodiments, the degradation detector 440 determines degradation scores for detected peer AVs. A degradation score may indicate a level of degradation in the detected state of the AV. In some embodiments, the degradation detector 440 may determine the degradation score further based on data indicating one or more conditions in the environment of the peer AV, such as the environment where the peer AV operates to provide a service. Examples of the environmental conditions include weather condition, road condition, traffic condition, network condition, condition of a remote system associated with the AV, and so on.

The degradation detector 440 may compare the degradation score with a threshold score to determine whether the AV is in a degraded state. For instance, in response to a determination that the degradation score is greater than (or at least equal to) the threshold score, the degradation detector 440 may determine that the AV is in a degraded state, versus the degradation detector 440 may determine that the AV is in not in a degraded state in response to a determination that the degradation score is no greater than (or lower than) the threshold score.

In some embodiments (e.g., embodiments where the degradation detector 440 determines that the AV is in a degraded state), the degradation detector 440 may also determine the severity of the AV's degradation, e.g., based on the degradation score, a duration of time the degradation lasts, other factors about the degradation, or some combination thereof. The degradation detector 440 may compare the degradation score with one or more threshold scores to determine the severity level of the AV's degradation. Different threshold scores may correspond to different levels of severity.

In an example, a degradation score below a first threshold score may indicate that the severity level of the degradation is very low (or that the AV is not in a degraded state). A degradation score above the first threshold score but below a second threshold score may indicate that the severity level of the degradation is low. A degradation score above the second threshold score but below a third threshold score may indicate that the severity level of the degradation is medium. A degradation score above the third threshold score may indicate that the severity level of the degradation is high. In other embodiments, the degradation detector 440 may use different, fewer, or more severity levels to measure the severity of the AV's degradation. The degradation detector 440 may provide information of the degraded state of the AV (e.g., the degradation score, the severity level, or both) to the reporting module 450.

The reporting module 450 reports degraded states of peer AVs. For instance, the reporting module 450 sends information of a degraded state of a peer AV to the fleet management system 120 so that the fleet management system 120 can address the degraded state of the peer AV. In some embodiments, the reporting module 450 determines the severity level of the degraded state of the peer AV and reports the degraded state when the severity level reaches or is above a threshold level. The reporting module 450 may provide information about the degradation (e.g., information about the cause of the degradation) to the fleet management system 120, and the fleet management system 120 may be able to recover the AV from the degradation through remotely controlling the AV, e.g., by updating the AV software, etc.

In some embodiments, the reporting module 450 may determine a solution to the degraded state of the peer AV based on the degradation detected by the degradation detector 440. For example, the reporting module 450 may determine that remote assistance is needed to address the degraded state of the peer AV and may instruct the reporting module 450 to request remote assistance for the peer AV. As another example, the reporting module 450 may determine that the peer AV would not be able to complete a service given the degraded state and may request the fleet management system 120 to deploy another peer AV to complete the service. As yet another example, the reporting module 450 may communicate with the onboard computer of the peer AV and instruct the peer AV to recover from the degraded state.

The reporting module 450 sends out requests for remote assistance based on information from the degradation detector 440. In an example, the reporting module 440 may determine that the AV's degraded state is at a high-severity level (e.g., based on a determination that the degradation score exceeds a threshold) and request remote assistance for the peer AV, e.g., through the fleet management system 120 (e.g., the remote assistance module 530 in the fleet management system 120). In some embodiments, the reporting module 450 may request a remote recovery of the peer AV, e.g., by the fleet management system 120. The reporting module 450 may instruct the degradation detector 440 to determine a new degradation score for the peer AV after the remote recovery. The reporting module 440 may determine that the recovery has failed (e.g., based on a determination that the new degradation score also exceeds the threshold) and request remote assistance for the peer AV.

Additionally or alternatively, the reporting module 450 may request a retrieval of the AV. The reporting module 450 may provide the location of the peer AV to the fleet management system 120 or a remote agent. The fleet management system 120 or remote agent may initiate a retrieval of the peer AV. For example, a driver may be provided, and the driver can drive the peer AV. As another example, a towing vehicle may be sent to the peer AV to tow the AV.

The degradation datastore 460 stores data received, used, or generated by the peer degradation module 350. For instance, the degradation datastore 460 may store degradations detected by the degradation detector 440. The degradation datastore 460 may also store data received from the fleet management system 120, e.g., data requested by the AV detector 420 or the degradation detector 440. In some embodiments, the degradation datastore 460 stores data of the AV detection model 430, such as internal parameters, hyperparameters, and so on. The degradation datastore 460 may be facilitated by one or more memories that are implemented in the detecting AV or one or more data storage systems in the Cloud.

### Example Fleet Management System

FIG. 5 is a block diagram showing the fleet management system 120, according to some embodiments of the present disclosure. The fleet management system 120 includes a client device interface 510, a vehicle manager 520, a remote assistance module 530, a user datastore 540, and a map datastore 550. In alternative configurations, different and/or additional components may be included in the fleet management system 120. Further, functionality attributed to one component of the fleet management system 120 may be accomplished by a different component included in the fleet management system 120 or a different system than those illustrated, such as the onboard computer 150.

The client device interface 510 provides interfaces to client devices, such as headsets, smartphones, tablets, computers, and so on. For example, the client device interface 510 may provide one or more apps or browser-based interfaces that can be accessed by users, such as the users 135, using client devices, such as the client devices 130. The client device interface 510 enables the users to submit requests to a ride service provided or enabled by the fleet management system 120. In particular, the client device interface 510 enables a user to submit a ride request that includes an origin (or pickup) location and a destination (or drop-off) location. The ride request may include additional information, such as a number of passengers travelling with the user, and whether or not the user is interested in a shared ride with one or more other passengers not known to the user.

The client device interface 510 can also enable users to select ride settings. The client device interface 510 can provide one or more options for the user to engage in a virtual environment, such as whether to interact with another person, whether to involve in an entertainment activity, and so on. The client device interface 510 may enable a user to opt-in to some, all, or none of the virtual activities offered by the ride service provider. The client device interface 510 may further enable the user to opt-in to certain monitoring features, e.g., to opt-in to have the interior sensors 240 obtain sensor data of the user. The client device interface 510 may explain how this data is used (e.g., for providing support to the user, etc.) and may enable users to selectively opt-in to certain monitoring features, or to opt-out of all of the monitoring features. In some embodiments, the user support platform may provide a modified version of a virtual activity if a user has opted out of some or all of the monitoring features.

The vehicle manager 520 manages and communicates with the fleet of AVs 110. The vehicle manager 520 assigns the AVs 110 to various tasks and directs the movements of the AVs 110 in the fleet. In some embodiments, the vehicle manager 520 selects AVs from the fleet to perform various tasks and instructs the AVs to perform the tasks. For example, the vehicle manager 520 receives a ride request from the client device interface 510. The vehicle manager 520 selects an AV 110 to service the ride request based on the information provided in the ride request, e.g., the origin and destination locations. If multiple AVs 110 in the AV 110 fleet are suitable for servicing the ride request, the vehicle manager 520 may match users for shared rides based on an expected compatibility. For example, the vehicle manager 520 may match users with similar user interests, e.g., as indicated by the user datastore 540. In some embodiments, the vehicle manager 520 may match users for shared rides based on previously-observed compatibility or incompatibility when the users had previously shared a ride.

In some embodiments, the vehicle manager 520 may instruct AVs 110 to drive to other locations while not servicing a user, e.g., to improve geographic distribution of the fleet, to anticipate demand at particular locations, etc. The vehicle manager 520 may also instruct AVs 110 to return to an AV 110 facility for fueling, inspection, maintenance, or storage.

The vehicle manager 520 or another system may maintain or access data describing each of the AVs in the fleet of AVs 110, including current location, service status (e.g., whether the AV 110 is available or performing a service; when the AV 110 is expected to become available; whether the AV 110 is schedule for future service), fuel or battery level, etc. The vehicle manager 520 may select AVs for service in a manner that optimizes one or more additional factors, including fleet distribution, fleet utilization, and energy consumption. The vehicle manager 520 may interface with one or more predictive algorithms that project future service requests and/or vehicle use, and select vehicles for services based on the projections.

The vehicle manager 520 transmits instructions dispatching the selected AVs. In particular, the vehicle manager 520 instructs a selected AV 110 to drive autonomously to a pickup location in the ride request and to pick up the user and, in some cases, to drive autonomously to a second pickup location in a second ride request to pick up a second user. The first and second user may jointly participate in a virtual activity, e.g., a cooperative game or a conversation. The vehicle manager 520 may dispatch the same AV 110 to pick up additional users at their pickup locations, e.g., the AV 110 may simultaneously provide rides to three, four, or more users. The vehicle manager 520 further instructs the AV 110 to drive autonomously to the respective destination locations of the users.

The vehicle manager 520 may facilitate detection of degraded AVs in the fleet of AVs. The vehicle manager 520 may communicate with AVs that can detect the degraded AVs in environments where the AVs operate. In some embodiments, the vehicle manager 520 may verify whether a vehicle is an AV in the fleet of AVs based on features of the vehicle detected by another AV. Examples of the features may include license plate, pattern, logo, shape, size, color, location, and so on. The vehicle manager 520 may check whether one or more features of the vehicle matches records of the AVs in the fleet. The vehicle manager 520 may also maintain digital twins of AVs. The vehicle manager 520 may determine that a vehicle matching a digital twin is an AV in the fleet. Additionally or alternatively, the vehicle manager 520 may facilitate encrypted communications between AVs in the fleet so that an AV can use the encrypted communication to identify another AV. For instance, the vehicle manager 520 may define an encrypted communication protocol. An AV can build encrypted communication with another AV using the encrypted communication protocol. The vehicle manager 520 may provide communication tokens to AVs in the fleet. An AV can build encrypted communication with another AV by verifying a communication token provided by the other AV.

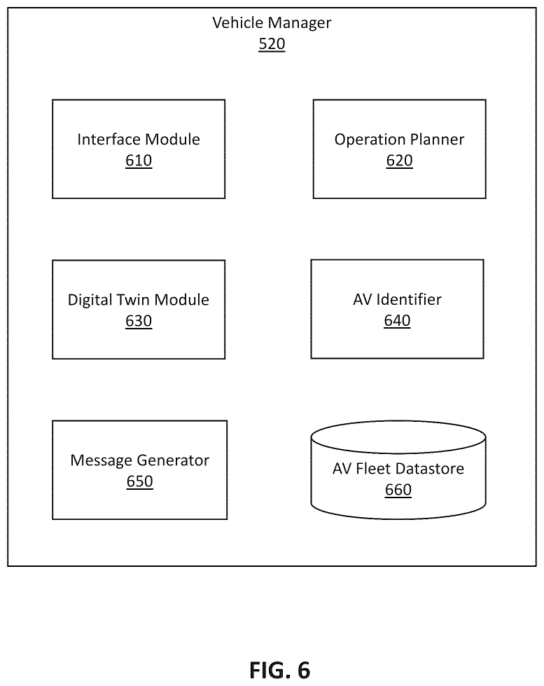

In some embodiments, the vehicle manager 520 may also provide information indicating the expected or desirable state of an AV. For instance, the vehicle manager 520 may maintain operational plans of AVs and the expected state of an AV can be determined based on one or more operational plans applicable to the AV. The information may be used to determine whether the AV is degraded, e.g., whether the real state of the AV deviates from the expected or desirable state. The vehicle manager 520 may also facilitate a degraded AV to recover from its degraded state. In situations where the degraded AV cannot be recovered, the vehicle manager 520 may dispatch another AV to replace the degraded AV for completing a task that is assigned to the degraded AV. Certain aspects of the vehicle manager 520 are provided below in conjunction with FIG. 6.

The remote assistance module 530 facilitates remote assistance for AVs, e.g., AVs with degraded states. In some embodiments, the remote assistance module 530 may receive remote assistance requests from AVs, e.g., AV that need remote assistance, AVs that request remote assistance for peer AVs, and so on. In other embodiments, remote assistance requests may also be received from passengers of AVs through the client device interface 510 or the onboard computer 150. The remote assistance module 530 manages the remote assistance requests. In some embodiments, the remote assistance module 530 maintains a queue of pending remote assistance requests, in which the pending remote assistance requests may be arranged in an order. A pending remote assistance request is a remote assistance request that has not been completed. A remote assistance request may be considered completed after the requested remote assistance has been provided or the issue that triggered the remote assistance request has been resolved.

The remote assistance module 530 may assign pending remote assistance requests to agents who can provide remote assistance to AVs or passengers. An agent can interact with the AV or passenger making the remote assistance request. An agent may be associated with a device in communication with the remote assistance module 530. The device may be a desktop or a laptop computer, a smartphone, a mobile telephone, a PDA, or another suitable device. The remote assistance module 530 may send the agent's device information related to remote assistance requests that are assigned to the agent. The information may include information about AVs that need remote assistance, such as description of degraded states of AVs (e.g., images, etc.), locations of AVs, information of environments of AVs, information of people or other objects impacted by degraded states of AVs, and so on. The remote assistance module 530 may also provide the agent with guidance on how to provide the requested support.

The user datastore 540 stores ride information associated with users of the ride service, e.g., the users 135. In some embodiments, the user datastore 540 stores user sentiments associated with rides taken by the user 135. The user sentiments may be determined by the remote assistance module 530. The user datastore 540 may store an origin location and a destination location for a user's current ride. The user datastore 540 may also store historical ride data for a user, including origin and destination locations, dates, and times of previous rides taken by a user. The historical data of the user may also include information associated with historical support requests made by the user during the previous rides, such as sensor data associated with the historical support requests, communications of the user with agents that serviced the historical support requests, states of the user during the communications, information of AVs 110 associated with the historical support requests, and so on. The historical data of the user may also include information associated with communications of AVs with the user for AV behaviors in historical rides taken by the user. In some cases, the user datastore 540 may further store future ride data, e.g., origin and destination locations, dates, and times of planned rides that a user has scheduled with the ride service provided by the AVs 110 and fleet management system 120. Some or all of the data of a user in the user datastore 540 may be received through the client device interface 510, an onboard computer (e.g., the onboard computer 150), a sensor suite of AVs 110 (e.g., the sensor suite 140), a third-party system associated with the user and the fleet management system 120, or other systems or devices.

In some embodiments, the user datastore 540 also stores data indicating user preferences associated with rides in AVs. The fleet management system 120 may include one or more learning modules (not shown in FIG. 5) to learn user interests based on user data. For example, a learning module may compare locations in the user datastore 540 with map datastore 550 to identify places the user has visited or plans to visit. For example, the learning module may compare an origin or destination address for a user in the user datastore 540 to an entry in the map datastore 550 that describes a building at that address. The map datastore 550 may indicate a building type, e.g., to determine that the user was picked up or dropped off at an event center, a restaurant, or a movie theater. In some embodiments, the learning module may further compare a date of the ride to event data from another data source (e.g., a third-party event data source, or a third-party movie data source) to identify a more particular interest, e.g., to identify a performer who performed at the event center on the day that the user was picked up from an event center, or to identify a movie that started shortly after the user was dropped off at a movie theater. This interest (e.g., the performer or movie) may be added to the user datastore 540. As another example, a learning module may learn user tolerance or preference for AV behaviors, e.g., based on information associated with communications of AVs with the user for AV behaviors in historical rides taken by the user. The learning module may learn that the user has a high tolerance for an AV behavior based on information indicating that the user had no bad feelings for the AV behavior undesirable in one or more previous rides. Similarly, the learning module may learn that the user has a low tolerance for a type of AV behavior based on information indicating that the user had negative sentiments towards the AV behavior in one or more previous rides.

The map datastore 550 stores a detailed map of environments through which the AVs 110 may travel. The map datastore 550 includes data describing roadways, such as e.g., locations of roadways, connections between roadways, roadway names, speed limits, traffic flow regulations, toll information, etc. The map datastore 550 may further include data describing buildings (e.g., locations of buildings, building geometry, building types), and data describing other objects (e.g., location, geometry, object type) that may be in the environments of AV 110. The map datastore 550 may also include data describing other features, such as bike lanes, sidewalks, crosswalks, traffic lights, parking lots, signs, billboards, etc.

Some of the map datastore 550 may be gathered by the fleet of AVs 110. For example, images obtained by the exterior sensors 210 of the AVs 110 may be used to learn information about the AVs' environments. As one example, AVs may capture images in a residential neighborhood during a holiday season, and the images may be processed to identify which homes have holiday decorations. The images may be processed to identify particular features in the environment. For the holiday decoration example, such features may include light color, light design (e.g., lights on trees, roof icicles, etc.), types of blow-up figures, etc. The fleet management system 120 and/or AVs 110 may have one or more image processing modules to identify features in the captured images or other sensor data. This feature data may be stored in the map datastore 550. In some embodiments, certain feature data (e.g., seasonal data, such as holiday decorations, or other features that are expected to be temporary) may expire after a certain period of time. In some embodiments, data captured by a second AV 110 may indicate that a previously-observed feature is no longer present (e.g., a blow-up Santa has been removed) and in response, the fleet management system 120 may remove this feature from the map datastore 550.

FIG. 6 is a block diagram showing the vehicle manager 520, according to some embodiments of the present disclosure. The vehicle manager 520 includes an interface module 610, an operation planner 620, a digital twin module 630, an AV identifier 640, a message generator 650, and an AV fleet datastore 660. In alternative configurations, different and/or additional components may be included in the vehicle manager 520. Further, functionality attributed to one component of the vehicle manager 520 may be accomplished by a different component included in the vehicle manager 520, a different component included in the fleet management system 120, or a different system (such as the onboard computer 150).

The interface module 610 facilitates communications of the vehicle manager 520 with other modules or systems. In some embodiments, the interface module 610 may facilitate communications of the vehicle manager 520 with the client device interface 510. For instance, the interface module 610 may receive data of service requests from the client device interface 510. The interface module 610 may also facilitate communications of the vehicle manager 520 with the remote assistance module 530. For instance, the interface module 610 may forward requests for remote assistance, e.g., after the vehicle manager 520 determines that such remote assistance is needed for AVs, to the remote assistance module 530. In some embodiments, the interface module 610 may facilitate communications of the vehicle manager 520 with onboard computers of AVs, including the onboard computer 150 (e.g., the peer degradation module 350 in the onboard computer 150). For instance, the interface module 610 may receive requests for verifying identities of AVs or requests for AV reference states from the onboard computer 150. The interface module 610 may also forward responses to such requests (or to other requests) to the onboard computer 150.

The operation planner 620 plans operations of AVs. In some embodiments, the operation planner 620 may generate one or more operational plans for controlling operations of the fleet of AVs, such as one or more ODDs. An operational plan may specify requirements or restrictions on AV behaviors, such as speed limit, acceleration limit, jerk limit, maneuver limit, and so on. In some embodiments, a requirement on restriction may be particular to an environmental condition, and the operational planner 620 may place different restrictions or requirements for different environmental conditions. The operation planner 620 may generate operational plans that are specific to one or more particular types of services. Operational plans generated by the operation planner 620 may be stored in the AV fleet datastore 660. An operational plan in the AV fleet datastore 660 may be associated with one or more AVs.

In some embodiments, the operation planner 620 may send the same operational plan to multiple AVs, e.g., AVs operating in the same area, AVs operating at the same time of period, AVs operating for providing the same type of service, and so on. The AVs 110, after receiving the operational plan, may be able to dynamically modify the operational plan based on information the AVs 110 obtain during their operations to maximize utilization and efficiency and minimize safety risks. The operation planner 620 may also generate multiple operational plans for the same AV, e.g., for different operations of the AV.

An operational plan may include information about a service, such as one or more locations associated with the service (e.g., pickup location, drop-off location, etc.), one or more timestamps associated with the service (e.g., pickup time, drop-off time, etc.), information about the user who requested the service (e.g., identification information, user location, user profile, etc.), and so on. An operational plan may also include information about an environment in which the AV 110 will operate to provide the service. The environment may be a real-world region, area, or scene. For instance, the operational plan may include information about one or more conditions in the environment (“environmental conditions”). Examples of environmental conditions include weather condition (e.g., rain, snow, wind, etc.), road condition (e.g., road closures, water accumulation, road grade indicating a rate of change of the road elevation, etc.), traffic condition (e.g., traffic congestion, accidents, etc.), other types of environmental conditions, or some combination thereof. In some embodiments, the operational plan may be an ODD.

In some embodiments, an operational plan may include one or more limitations on the operation of the AV 110 for providing the service. Example limitations include limitation on an attribute of the AV 110, limitation on a movement of the AV 110, limitation on an environment where the AV 110 performs at least part of the operation, limitation on a time when the AV 110 performs at least part of the operation, other types of limitations, or some combination thereof. The AV 110 can plan and control its behaviors during the operation based on the limitations.

In some embodiments, an operational plan may be pre-defined, and the operation planner 620 may generate the operational plan before the AV 110 operates to perform the service task. The operation planner 620 may generate the operational plan based on information that is obtained by the operation planner 620 before the operation of the AV 110. The information may be data received by the operation planner 620 from the AV 110 or one or more other AVs 110, such as sensor data collected by the sensor suite 140 of each AV 110 during a historical operation. The historical operation may be in the same environment (e.g., same city, region, block, etc.) as the operation to be performed by the AV 110. Additionally or alternatively, the historical operation may be performed to provide the same type of service or to provide service to the same user (or the same group of users). The information may also include data received from third-party systems, such as systems that provide maps, weather predictions, road information, traffic information, and so on. The information may also include traffic rules, such as speed limit, requirement of yielding to pedestrians, restriction on an AV maneuver (e.g., U-turn, unprotected left turn, backing up, etc.), and so on.

The digital twin module 630 generates and maintains digital twins of AVs. A digital twin may be a digital representation of an AV (which may be referred to in this context as a physical twin) that serves as the AVs digital, or virtual, counterpart for simulation (and in the present context, for RA scenario simulation) purposes. In some embodiments, a digital twin may include a two-dimensional or three-dimensional graphic representation of the AV. The digital twin module 630 may generate a digital twin of an AV based on components of the AV, functions of the AV, manual of the AV, and so on. The digital twin may include virtual components that represent corresponding components of the AV. The digital twin module 630 may generate more than one digital twin for an AV. Also, the digital twin module 630 may generate a single digital twin for multiple AVs. In some embodiments, the digital twin module 630 may also generate one or more simulated scenes. A simulated scene may be a virtual representation of a real-world scene in which the AV operates. A simulated scene may include virtual objects representing real-world objects in the corresponding real-world scene.

In some embodiments, the digital twin of an AV may be used in real time and is regularly synchronized with the AV. The digital twin module 630 may receive real-time data (e.g., real-time sensor data, real-time perception data, real-time planning data, etc.) from the AV (e.g., from the onboard computer 150 of the AV). The digital twin module 630 may update the digital twin based on the real-time data. Additionally, the digital other real-time data from other sources (including, but not limited to, traffic data, traffic light timing, visibility, weather information, VRU heat maps) that might be useful in assessing an RA event of the AV is also provided to the digital twin. The digital twin may perform perception/motion control/path planning in parallel with the AV and subsequently output information.

The AV identifier 640 determines whether vehicles (e.g., vehicles detected by AVs) are in the fleet of AVs that is managed by the vehicle manager 520. The AV identifier 640 may receive requests for confirming identities of vehicles from detecting AVs. The vehicles may be preliminarily identified as AVs managed by the vehicle manager 520 by the detecting AVs, such as the peer degradation module 350. The AV identifier 640 may confirm whether preliminary identifications of the AVs are correct or not.

In some embodiments, the AV identifier 640 may determine whether a detected vehicle is managed by the vehicle manager 520 based on sensor data or perception data received from the detecting AV. The AV identifier 640 may identify a feature of the detected vehicle based on the data from the detecting AV. The feature may be the license plate of the detected vehicle, one or more exterior features (e.g., pattern, sign, color, etc.) of the detected vehicle, the location of the detected vehicle, and so on. The AV identifier 640 may further check the identified feature against records of AVs maintained by the vehicle manager 520. The AV records may be stored in the AV fleet datastore 660. An AV record may store identifying information of the AV (e.g., serial number, name, license plate, vehicle identifying number, etc.), descriptions of the AV (e.g., year, model, shape, color, size, etc.), operational plan of the AV (e.g., travelling route, destination, etc.), or other information about the AV.

In addition or alternative to AV records, the AV identifier 640 may use digital twins to determine whether detected vehicles are managed by the vehicle manager 520. For instance, the AV identifier 640 may determine whether one or more identified features of a detected vehicle match corresponding features of a digital twin generated or maintained by the digital twin module 630. In embodiments where there is a match between the detected vehicle and a record or there is a match between the detected vehicle and a digital twin, the AV identifier 640 may confirm that the detected vehicle is in the fleet of AVs. In embodiments where there is no match, the AV identifier 640 may confirm that the AV is not in the fleet of AVs. The AV identifier 640 may send confirmations to the detecting AVs.

The message generator 650 generates messages that can be used to communicate with humans with respect to degraded states of AVs. For instance, the messages may be used to communicate with users who receive services provided by the AVs. The message generator 650 may generate the messages based on information of the detected degraded states of AVs, e.g., information received from the peer degradation module 350. A message may include information that can help with minimizing or even eliminating the impact of the AV degradation on the service provided to the user. The messages may also improve the user's satisfaction with the service.

In some embodiments, the information in the one or more messages may be an acknowledgment of the degraded state of the AV, a reason why the degraded state happened, a query of the user's comment or feedback, a solution to address the degraded state of the AV or to address a problem caused by the degraded state of the AV, other information, or some combination thereof. In an example, a message to a passenger may inform the passenger that the AV is not in a condition to complete the ride anymore and may provide the passenger an option to transfer to another AV for the ride. As another example, a message may indicate that the delivery of an item by the AV may be delayed given the degraded state of the AV. The message may also provide an updated delivery time to the user.

A message may include text, audio, image (e.g., static image, animated image, video, etc.), light, other types of communication signals, or some combination thereof. In some embodiments, a message may include one or more UI elements, through which the person can respond to the message. In some embodiments, the one or more UI elements may facilitate the person to provide a response to the message. The message generator 650 may generate one or more other messages based on the person's response. The message generator 650 can facilitate a dynamic, unique, and personalized conversation with the person.

In some embodiments, a message may include options for the person to modify the operation of the degraded AV. For instance, a message may allow a passenger of the AV to modify the ride. For instance, the message generator 650 may generate a message including an option for the person to change the destination of the ride, change the route of the ride, terminate the ride, and so on. The message generator 650 may include one or more optional settings of the ride (which may be different from the current settings of the ride) in the message and the person can select the one or more optional settings. The message generator 650 may determine the one or more optional settings based on the degraded state of the AV or the reason why the degraded state happened. In an example where the degraded state of the AV prevents the AV from taking the original travelling route, the message generator 650 may determine one or more alternative routes to the person's destination and include the alternative routes in the message so that the person can select an alternative route for the ride. Alternatively, the message generator 650 may allow the person to change the destination. The message generator 650 may identify one or more alternative destinations, which may be similar as the original destination, e.g., may provide the same types of service or product. The message generator 650 may include the one or more alternative destinations to the message so that the person can select an alternative destination for the ride.

### Example Method of Detecting and Reporting AV Degraded States

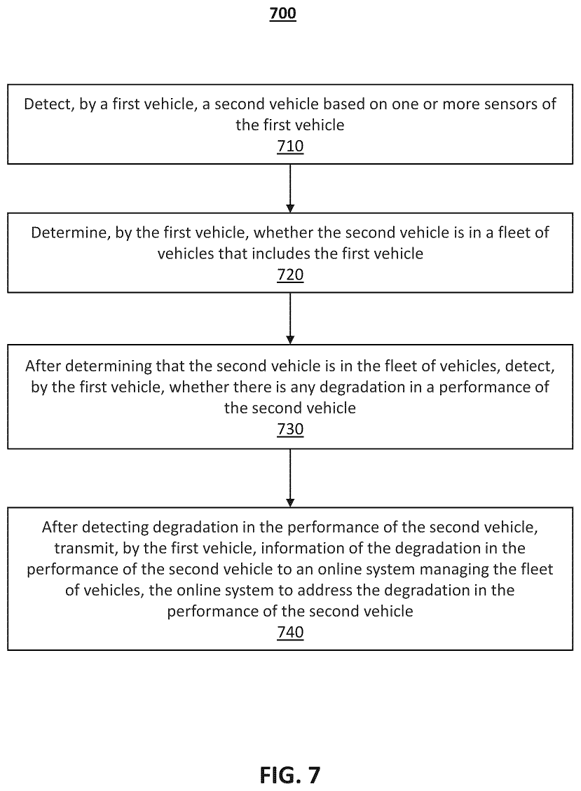

FIG. 7 is a flowchart showing a method 700 of detecting and reporting degraded states of AVs, according to some embodiments of the present disclosure. The method 700 may be performed by the peer degradation module 350. The peer degradation module 350 may be in the onboard computer 150 of a detecting AV, which is referred to as a first vehicle hereinafter. Although the method 700 is described with reference to the flowchart illustrated in FIG. 7, many other methods of detecting and reporting degraded states of AVs may alternatively be used. For example, the order of execution of the steps in FIG. 7 may be changed. As another example, some of the steps may be changed, eliminated, or combined.

The peer degradation module 350 detects, in 710, a second vehicle based on one or more sensors of the first vehicle. The one or more sensors of the first vehicle may include camera sensor, LIDAR sensor, and so on. The second vehicle may be present in an area surrounding the first vehicle.

The peer degradation module 350 determines, in 720, the second vehicle is in a fleet of vehicles that includes the first vehicle. In some embodiments, the peer degradation module 350 inputs data from the one or more sensors of the first vehicle into a trained model. The trained model outputs a determination whether the second vehicle is in the fleet of vehicles.

In some embodiments, the peer degradation module 350 also determines whether a confidence of the training model for the determination is lower than a threshold. In response to determining that the confidence is lower than the thresholding, the peer degradation module 350 sends, to the online system, a request for determining whether the second vehicle is in the fleet of vehicles. The request comprises information of one or more features of the second vehicle that are captured by the first vehicle, and the online system is to determine an identity of the second vehicle based on the one or more features of the second vehicle. The peer degradation module 350 determines whether the second vehicle is in the fleet of vehicles based on a response from the online system. The online system may manage the fleet of vehicles. An example of the online system may be the fleet management system 120.

In some embodiments, the peer degradation module 350 sends a request for establishing wireless communication. The wireless communication is based on an encrypted communication protocol. After the wireless communication is established, the peer degradation module 350 determines that the second vehicle is in the fleet of vehicles. The wireless communication may be encrypted.

After determining that the second vehicle is in the fleet of vehicles, the peer degradation module 350 detects, in 730, whether there is any degradation in the state of the second vehicle. In some embodiments, the peer degradation module 350 determines the state of the second vehicle. The peer degradation module 350 retrieves information of a reference state of the second vehicle from a memory of the first vehicle or receives information indicating a reference state of the second vehicle from the online system. The peer degradation module 350 determines whether the state of the second vehicle matches the reference state.

In some embodiments, the state of the second vehicle comprises a location of the second vehicle. The information indicating the reference state of the second vehicle comprises information of a travelling route of the second vehicle. The peer degradation module 350 determines whether the second vehicle deviates from the travelling route based on the location of the second vehicle.

In some embodiments, the peer degradation module 350 captures, using a camera of the first vehicle, one or more images of the second vehicle. The peer degradation module 350 determines whether the second vehicle has any damage based on the one or more images.

After detecting degradation in the state of the second vehicle, the peer degradation module 350 transmits, in 740, information of the degradation in the state of the second vehicle to an online system managing the fleet of vehicles. The online system is to address the degradation in the state of the second vehicle. In some embodiments, the online system is to send a message to a client device associated with a passenger of the second vehicle based on the degradation in the state of the second vehicle.

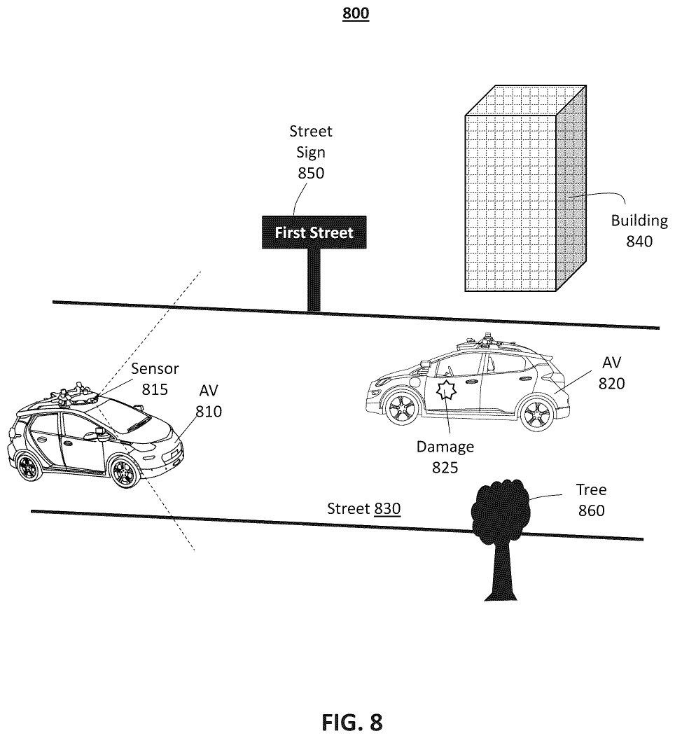

FIG. 8 illustrates a scene 800 where an AV 810 detects and reports a degraded state of another AV 820, according to some embodiments of the present disclosure. The AVs 810 and 820 may be examples of AV 110. The scene 800 may be a real-world environment in which the AV 810 operates, e.g., for performing a service or for other purposes. The AV 810 drives on a street 830 in the scene 800. The scene 800 also includes a building 840, a street sign 850, and a tree 860. In other embodiments, the scene 800 may include fewer, more, or different objects. For instance, the scene 800 may include other vehicles or pedestrians.

The AV 810 has a sensor 815. The sensor 815 may be an exterior sensor, such as the exterior sensors 210 in FIG. 2. For the purpose of illustration, the sensor 815 is fixed on the top of the AV 810 in FIG. 8. In other embodiments, the sensor 815 may be fixed on another exterior surface of the AV 810 or be fixed inside the AV 810 but can perceive other objects in the scene 800. The sensor 815 has a field of view that extends out of the AV 810. The field of view of the sensor 815 is represented by the dashed lines in FIG. 810. The sensor 815 may detect the building 840, street sign 850, and tree 860. The detection of the sensor 815 can facilitate localization and navigation of the AV 810 in the scene 800. Also, the sensor 815 can facilitate the AV 810 to peer AVs, such as the AV 820, in the scene 800, and to detect degraded states of peer AVs.

In the embodiments of FIG. 8, the sensor 815 captures one or more features of the AV 820, which also operates in the scene 800. The one or more features may include logo, license plate, shape, size, text, location, and so on. Based on sensor data from the sensor 815, the AV 810 may determine that the AV 820 is a peer AV. Additionally or alternatively, the AV 810 may request a communication with the AV 820 or request an online system (e.g., the fleet management system 120) to determine whether the AV 820 is a peer AV. The AV 810 also detects a damage 825 on the AV 820 based on sensor data from the sensor 815. The AV 810 may classify the damage 825 as a degraded state, e.g., based on a determination that the damage 825 is not an expected feature of the AV 820. In some embodiments, the AV 810 may perform the method 700 in FIG. 7.

After the AV 810 detects and classifies the damage 825, the AV 810 may report to the fleet management system 120 that the AV 820 is having a degraded state. The AV 810 may also provide information about the degraded state, such as an image of the damage 825, location of the AV 820 (which may be indicated by the location of the building 840, the street sign 850, the location of the AV 810, etc.), degradation extent of the damage 825, and so on. The fleet management system 120 may determine whether to take any action to address the degraded state of the AV 820. For instance, the fleet management system 120 may determine whether to dispatch another AV to replace the AV 820, to request or provide remote assistance, to instruct the AV 820 to a location where the damage 825 can be fixed, and so on.

### Select Examples

Example 1 provides a method, including: detecting, by a first vehicle, a second vehicle based on one or more sensors of the first vehicle; determining whether the second vehicle is in a fleet of vehicles that includes the first vehicle; after determining that the second vehicle is in the fleet of vehicles, detecting, by the first vehicle, whether there is a degradation in a state of the second vehicle; and after detecting degradation in the state of the second vehicle, transmitting, by the first vehicle, information of the degradation in the state of the second vehicle to an online system managing the fleet of vehicles, the online system to address the degradation in the state of the second vehicle.

Example 2 provides the method of example 1, where determining whether the second vehicle is in the fleet of vehicles includes: inputting data from the one or more sensors into a machine learning model, the machine learning model outputting a determination whether the second vehicle is in the fleet of vehicles.

Example 3 provides the method of example 2, where determining whether the second vehicle is in the fleet of vehicles further includes: determining whether a confidence of the training model for the determination is lower than a threshold; in response to determining that the confidence is lower than the thresholding, sending, to the online system, a request for determining whether the second vehicle is in the fleet of vehicles; and determining whether the second vehicle is in the fleet of vehicles based on a response from the online system.

Example 4 provides the method of example 3, where the request includes information of one or more features of the second vehicle that are captured by the first vehicle, and the online system is to determine an identity of the second vehicle based on the one or more features of the second vehicle.

Example 5 provides the method of any one of examples 1-4, where determining whether the second vehicle is in the fleet of vehicles includes: sending, by the first vehicle to the second vehicle, a request for establishing wireless communication, where the wireless communication is based on an encrypted communication protocol; and after the wireless communication is established, determining that the second vehicle is in the fleet of vehicle.

Example 6 provides the method of any one of examples 1-5 where detecting whether there is any degradation in the state of the second vehicle includes: identifying the state of the second vehicle; and determining whether the state of the second vehicle matches a reference state.

Example 7 provides the method of example 6, where detecting whether there is any degradation in the state of the second vehicle further includes: receiving information indicating a reference state of the second vehicle from the online system; and determining the reference state based on the information.

Example 8 provides the method of example 6 or 7, where detecting whether there is any degradation in the state of the second vehicle further includes: retrieving information of a reference state of the second vehicle from a memory of the first vehicle; and determining the reference state based on the information.

Example 9 provides the method of any one of examples 6-8, where: the state of the second vehicle includes a location of the second vehicle, the information indicating the reference state of the second vehicle includes information of a travelling route of the second vehicle, and detecting whether there is any degradation in the state of the second vehicle further includes determining whether the second vehicle deviates from the travelling route based on the location of the second vehicle.

Example 10 provides the method of any one of examples 1-9, where the online system is to send a message to a client device associated with a passenger of the second vehicle based on the degradation in the state of the second vehicle.

Example 11 provides one or more non-transitory computer-readable media storing instructions executable to perform operations, the operations including: detecting, by a first vehicle, a second vehicle based on one or more sensors of the first vehicle; determining whether the second vehicle is in a fleet of vehicles that includes the first vehicle; after determining that the second vehicle is in the fleet of vehicles, detecting, by the first vehicle, whether there is a degradation in a state of the second vehicle; and after detecting degradation in the state of the second vehicle, transmitting, by the first vehicle, information of the degradation in the state of the second vehicle to an online system managing the fleet of vehicles, the online system to address the degradation in the state of the second vehicle.

Example 12 provides the one or more non-transitory computer-readable media of example 11, where determining whether the second vehicle is in the fleet of vehicles includes: inputting data from the one or more sensors into a machine learning model, the machine learning model outputting a determination whether the second vehicle is in the fleet of vehicles.

Example 13 provides the one or more non-transitory computer-readable media of example 12, where determining whether the second vehicle is in the fleet of vehicles further includes: determining whether a confidence of the training model for the determination is lower than a threshold; in response to determining that the confidence is lower than the thresholding, sending, to the online system, a request for determining whether the second vehicle is in the fleet of vehicles; and determining whether the second vehicle is in the fleet of vehicles based on a response from the online system.

Example 14 provides the one or more non-transitory computer-readable media of any one of examples 11-13, where determining whether the second vehicle is in the fleet of vehicles includes: sending, by the first vehicle to the second vehicle, a request for establishing wireless communication, where the wireless communication is based on an encrypted communication protocol; and after the wireless communication is established, determining that the second vehicle is in the fleet of vehicle.

Example 15 provides the one or more non-transitory computer-readable media of any one of examples 11-14, where detecting whether there is any degradation in the state of the second vehicle includes: identifying the state of the second vehicle; and determining whether the state of the second vehicle matches a reference state.

Example 16 provides the one or more non-transitory computer-readable media of example 15, where detecting whether there is any degradation in the state of the second vehicle further includes: receiving information indicating a reference state of the second vehicle from the online system; or retrieving information of a reference state of the second vehicle from a memory of the first vehicle.

Example 17 provides a computer system, including: a computer processor for executing computer program instructions; and one or more non-transitory computer-readable media storing computer program instructions executable by the computer processor to perform operations including: detecting, by a first vehicle, a second vehicle based on one or more sensors of the first vehicle, determining whether the second vehicle is in a fleet of vehicles that includes the first vehicle, after determining that the second vehicle is in the fleet of vehicles, detecting, by the first vehicle, whether there is a degradation in a state of the second vehicle, and after detecting degradation in the state of the second vehicle, transmitting, by the first vehicle, information of the degradation in the state of the second vehicle to an online system managing the fleet of vehicles, the online system to address the degradation in the state of the second vehicle.

Example 18 provides the computer system of example 17, where determining whether the second vehicle is in the fleet of vehicles includes: inputting data from the one or more sensors into a machine learning model, the machine learning model outputting a determination whether the second vehicle is in the fleet of vehicles; determining whether a confidence of the training model for the determination is lower than a threshold; in response to determining that the confidence is lower than the thresholding, sending, to the online system, a request for determining whether the second vehicle is in the fleet of vehicles; and determining whether the second vehicle is in the fleet of vehicles based on a response from the online system

Example 19 provides the computer system of example 17 or 18, where determining whether the second vehicle is in the fleet of vehicles includes: sending, by the first vehicle to the second vehicle, a request for establishing wireless communication, where the wireless communication is based on an encrypted communication protocol; and after the wireless communication is established, determining that the second vehicle is in the fleet of vehicle

Example 20 provides the computer system of any one of examples 17-19, where detecting whether there is any degradation in the state of the second vehicle includes: identifying the state of the second vehicle; and determining whether the state of the second vehicle matches a reference state.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along with similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

What is claimed is:

1. A method, comprising:
detecting, by a first vehicle, a second vehicle based on one or more sensors of the first vehicle;
determining whether the second vehicle is in a fleet of vehicles that includes the first vehicle;
after determining that the second vehicle is in the fleet of vehicles, detecting, by the first vehicle, whether there is a degradation in a state of the second vehicle; and
after detecting degradation in the state of the second vehicle, transmitting, by the first vehicle, information of the degradation in the state of the second vehicle to an online system managing the fleet of vehicles, the online system to address the degradation in the state of the second vehicle.

2. The method of claim 1, wherein determining whether the second vehicle is in the fleet of vehicles comprises:
inputting data from the one or more sensors into a machine learning model, the machine learning model outputting a determination whether the second vehicle is in the fleet of vehicles.

3. The method of claim 2, wherein determining whether the second vehicle is in the fleet of vehicles further comprises:
determining whether a confidence of the machine learning model for the determination is lower than a threshold;
in response to determining that the confidence is lower than the thresholding, sending, to the online system, a request for determining whether the second vehicle is in the fleet of vehicles; and
determining whether the second vehicle is in the fleet of vehicles based on a response from the online system.

4. The method of claim 3, wherein the request comprises information of one or more features of the second vehicle that are captured by the first vehicle, and the online system is to determine an identity of the second vehicle based on the one or more features of the second vehicle.

5. The method of claim 1, wherein determining whether the second vehicle is in the fleet of vehicles comprises:
sending, by the first vehicle to the second vehicle, a request for establishing wireless communication, wherein the wireless communication is based on an encrypted communication protocol; and
after the wireless communication is established, determining that the second vehicle is in the fleet of vehicle.

6. The method of claim 1, wherein detecting whether there is any degradation in the state of the second vehicle comprises:
determining whether the state of the second vehicle matches a reference state.

7. The method of claim 6, wherein detecting whether there is any degradation in the state of the second vehicle further comprises:
receiving information indicating the reference state of the second vehicle from the online system; and
determining the reference state of the second vehicle based on the information.

8. The method of claim 6, wherein detecting whether there is any degradation in the state of the second vehicle further comprises:
retrieving information of a reference state of the second vehicle from a memory of the first vehicle; and
determining the reference state of the second vehicle based on the information.

9. The method of claim 6, wherein:
the state of the second vehicle comprises a location of the second vehicle,
the information indicating the reference state of the second vehicle comprises information of a travelling route of the second vehicle, and
detecting whether there is any degradation in the state of the second vehicle further comprises determining whether the second vehicle deviates from the travelling route based on the location of the second vehicle.

10. The method of claim 1, wherein the online system is to send a message to a client device associated with a passenger of the second vehicle based on the degradation in the state of the second vehicle.

11. One or more non-transitory computer-readable media storing instructions executable to perform operations, the operations comprising:
detecting, by a first vehicle, a second vehicle based on one or more sensors of the first vehicle;
determining whether the second vehicle is in a fleet of vehicles that includes the first vehicle;
after determining that the second vehicle is in the fleet of vehicles, detecting, by the first vehicle, whether there is a degradation in a state of the second vehicle; and
after detecting degradation in the state of the second vehicle, transmitting, by the first vehicle, information of the degradation in the state of the second vehicle to an online system managing the fleet of vehicles, the online system to address the degradation in the state of the second vehicle.

12. The one or more non-transitory computer-readable media of claim 11, wherein determining whether the second vehicle is in the fleet of vehicles comprises:
inputting data from the one or more sensors into a machine learning model, the machine learning model outputting a determination whether the second vehicle is in the fleet of vehicles.

13. The one or more non-transitory computer-readable media of claim 12, wherein determining whether the second vehicle is in the fleet of vehicles further comprises:
determining whether a confidence of the training model for the determination is lower than a threshold;
in response to determining that the confidence is lower than the thresholding, sending, to the online system, a request for determining whether the second vehicle is in the fleet of vehicles; and
determining whether the second vehicle is in the fleet of vehicles based on a response from the online system.

14. The one or more non-transitory computer-readable media of claim 11, wherein determining whether the second vehicle is in the fleet of vehicles comprises:
sending, by the first vehicle to the second vehicle, a request for establishing wireless communication, wherein the wireless communication is based on an encrypted communication protocol; and
after the wireless communication is established, determining that the second vehicle is in the fleet of vehicle.

15. The one or more non-transitory computer-readable media of claim 11, wherein detecting whether there is any degradation in the state of the second vehicle comprises:
identifying the state of the second vehicle; and
determining whether the state of the second vehicle matches a reference state.

16. The one or more non-transitory computer-readable media of claim 15, wherein detecting whether there is any degradation in the state of the second vehicle further comprises:
receiving information indicating a reference state of the second vehicle from the online system; or
retrieving information of a reference state of the second vehicle from a memory of the first vehicle.

17. A computer system, comprising:
a computer processor for executing computer program instructions; and
one or more non-transitory computer-readable media storing computer program instructions executable by the computer processor to perform operations comprising:
detecting, by a first vehicle, a second vehicle based on one or more sensors of the first vehicle,
determining whether the second vehicle is in a fleet of vehicles that includes the first vehicle,
after determining that the second vehicle is in the fleet of vehicles, detecting, by the first vehicle, whether there is a degradation in a state of the second vehicle, and
after detecting degradation in the state of the second vehicle, transmitting, by the first vehicle, information of the degradation in the state of the second vehicle to an online system managing the fleet of vehicles, the online system to address the degradation in the state of the second vehicle.

18. The computer system of claim 17, wherein determining whether the second vehicle is in the fleet of vehicles comprises:
inputting data from the one or more sensors into a machine learning model, the machine learning model outputting a determination whether the second vehicle is in the fleet of vehicles;
determining whether a confidence of the training model for the determination is lower than a threshold;
in response to determining that the confidence is lower than the thresholding, sending, to the online system, a request for determining whether the second vehicle is in the fleet of vehicles; and
determining whether the second vehicle is in the fleet of vehicles based on a response from the online system.

19. The computer system of claim 17, wherein determining whether the second vehicle is in the fleet of vehicles comprises:
sending, by the first vehicle to the second vehicle, a request for establishing wireless communication, wherein the wireless communication is based on an encrypted communication protocol; and
after the wireless communication is established, determining that the second vehicle is in the fleet of vehicle.

20. The computer system of claim 17, wherein detecting whether there is any degradation in the state of the second vehicle comprises:
identifying the state of the second vehicle; and
determining whether the state of the second vehicle matches a reference state.
